(19) United States
(12) Patent Application Publication
(10) Pub. No.: US 2015/0024122 A1
(43) Pub. Date: Jan. 22, 2015

(54) GRAPHENE INK AND METHOD FOR MANUFACTURING GRAPHENE PATTERN USING THE SAME

(71) Applicant: Enerage Inc., Wujie Township (TW)

(72) Inventors: Mark Y. WU, Wujie Township (TW); Cheng-Yu Hsieh, Wujie Township (TW); Rui-Jun Cheng, Wujie Township (TW); Cheng-Shu Peng, Wujie Township (TW)

(73) Assignee: Enerage Inc., Wujie Township (TW)

(21) Appl. No.: 14/032,702

(22) Filed: Sep. 20, 2013

(30) Foreign Application Priority Data
Jul. 16, 2013 (TW) 102125396

(51) Int. Cl. C09D 11/00

(52) U.S. Cl. CPC C09D 11/52; C08K 3/04
USPC 427/122; 252/511; 252/503

(57) ABSTRACT

A graphene ink includes a dispersion solution with a surface tension between 35 and 55 mJ/m², a polymer binder dissolved in the dispersion solution to form a colloidal solution, and a plurality of graphene sheets dispersed in the colloidal solution with a suspension concentration of 0.1˜5 wt %. The graphene ink has a viscosity less than 100 cp and a surface potential greater than 30 mV or less than −30 mV. The graphene ink is first prepared and then processed by the steps of masking, spraying, solidifying and removing so as to form a graphene pattern by patterning the graphene ink on an electrical insulation substrate.

### CROSS-REFERENCES TO RELATED APPLICATIONS

This application claims the priority of Taiwanese Patent application No. 102125396, filed on Jul. 16, 2013, which is incorporated herewith by reference.

### BACKGROUND OF THE INVENTION

1. Field of the Invention

The present invention generally relates to a graphene ink, and more specifically to a graphene ink and a method for manufacturing graphene pattern using the graphene ink.

2. The Prior Arts

Recently, conductive ink has been widely used in spray type electronic devices or electronic circuits. For example, U.S. Pat. No. 7,834,295 disclosed a printer with igniter, in which an electrically conductive material and a binder are used to prepare a conductive ink, wherein the igniter is formed via spraying the conductive ink. Also, a method of increasing conductivity of an ink disclosed in U.S. Pat. No. 7,097,788 includes the steps of forming conductive anisotropic particles by means of rubbing, and forming a conductive ink by adding a solvent, without using the traditional high temperature curing treatment to manufacture electronic devices. In particular, the conductive ink is applicable to electrochemical sensors.

In general, the monolayer graphite, also called graphene, has a two-dimensional structure formed of a monolayer of carbon atoms tightly packed in honeycomb crystal lattice by the graphitic bond (sp2). That is, graphene has a thickness of only one carbon atom. The graphitic bond is a hybrid chemical bond derived from the covalent bond and the metallic bond. It is believed that graphene is a perfect substance with both primary properties of an electrical insulator and conductor. Therefore, Andre Geim and Konstantin Novoselov, who successfully proved that graphene is obtained by peeling a piece of graphite with adhesive tape at the University of Manchester in the UK in 2004, were awarded the Nobel Prize in Physics for 2010.

At present, Graphene is well known as the thinnest and hardest material. Specifically, its thermal conductivity is greater than that of carbon nanotube and diamond, and its electron mobility at room temperature is higher than that of the carbon nanotube and silicon crystal. Also, electric resistivity of graphene is even lower than that of copper or silver, and so far, graphene is considered as the material with the lowest resistivity. It is possibly expected that graphene has a wide field of application, and is applicable to the conductive ink so as to increase its electrical conductivity. U.S. patent publication No. 20100000441 A1 disclosed a nano graphene platelet-based conductive ink including nano graphene platelets and a liquid medium in which the nano graphene platelets are dispersed. Specifically, the nano graphene platelets occupy a proportion of at least 0.001% by volume based on the total ink volume.

However, with the natural nano structure of graphene, its packing density is far smaller than 0.01 g/cm³ and its volume is considerably large. Furthermore, it is easy for a large amount of graphenes to congregate together due to van der Waals forces. Thus, even with these excellent physical properties, it is a great challenge for Graphene to be widely implemented in mass production for industrial application. Particularly, it may cause many negative effects in derived products.

Therefore, it is greatly desired to provide a graphene ink and a method for manufacturing graphene pattern to overcome the above problems in the prior arts.

### SUMMARY OF THE INVENTION

The primary objective of the present invention is to provide a graphene ink including a dispersion solution, a polymer binder and a plurality of graphene sheets. The dispersion solution includes at least one solvent, and is more than 99 wt % (weight percent) of the graphene ink. The dispersion solution also has a surface tension between 35 and 55 mJ/m². The polymer binder is well dissolved in the dispersion solution to form a colloidal solution. The polymer binder is 0.01˜0.5 wt %. The graphene sheets are dispersed in the colloidal solution with a suspension concentration of 0.1˜5 wt %. The graphene ink has a viscosity less than 100 cp and a surface potential greater than 30 mV or less than −30 mV.

Another objective of the present invention is to provide a method for manufacturing graphene pattern, including the steps of preparing, masking, spraying, solidifying and removing. The graphene ink as mentioned above is first prepared in the preparing step, and a patterned photoresist is coated or a patterned mask is provided on an insulation substrate in the step of masking. The step of spraying is then performed to apply the graphene ink onto the insulation substrate such that the surface region of the insulation substrate which is not masked by the patterned photoresist or the patterned mask is covered with the graphene ink. Next, the graphene ink on the insulation substrate is heated and solidified in the solidifying step to evaporate volatile matters from the graphene ink. Finally, the removing step is performed to remove the patterned photoresist by a chemical means or the patterned mask by a mechanical means. As a result, a graphene pattern, that is, the solidified graphene ink left on the insulation substrate, is formed. The insulation substrate can be implemented by the PET substrate, BT substrate, or glass fiber substrate used in the traditional printed circuit board, glass or plastic tape. Therefore, the graphene pattern can be manufactured in various forms, like circuit board, conductive glass, conductive tape, and so on.

One of the primary features of the present invention is that the graphene possessing excellent electrical and thermal conductivities is first processed to form the graphene ink which is easy to spray onto the surface of the target product and then form the graphene pattern or conductive film by patterning. Various graphene products are thus specifically implemented.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart illustrating the processing steps of the method for manufacturing graphene pattern according to the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within e spirit of the present invention.

The graphene ink according to the present invention includes a dispersion solution, a polymer binder and a plurality of graphene sheets. Specifically, the dispersion solution includes at least one solvent and occupies a proportion of more than 99% by weight based on a total graphene ink weight, that is, more than 99 wt % (weight percent) of the graphene ink. Further, the dispersion solution has a surface tension between 35 and 55 mJ/m². The polymer binder is well dissolved in the dispersion solution to form a colloidal solution, and occupies 0.01˜0.5 wt % of the graphene ink. The graphene sheets are well dispersed in the colloidal solution with a suspension concentration of 0.1˜5 wt %. As a result, the graphene ink has a viscosity less than 100 cp and its surface potential is greater than 30 mV or less than −30 mV.

The dispersion solution includes at least one solvent, which is selected from a group consisting of water, organic solvent, or ionic solution. The dispersion solution further includes a modifying reagent, such as a surfactant and/or a dispersant, which is gradually added into the solvent to adjust the surface tension of the dispersion solution between 35 and 55 mJ/m². Specifically, the modifying reagent is selected, from a group consisting of at least one of organic acids, alcohols, aldehydes, esters, amines, inorganic bases and inorganic salts.

The graphene sheets are formed as a shape of flake. The thickness of the graphene sheet is 1˜10 nm and its lateral size is 1˜10 μm. Preferably, a ratio of the lateral size to the thickness of the graphene sheet is greater than 1,000, and a specific area of the graphene sheet is more than 400 m²/g. Moreover, the graphene sheet has a contact angle with respect to the colloidal solution within a range of 45 to 80 degrees.

The polymer binder consists of at least one of a thermoplastic resin, a thermoset resin, cellulose and a conductive polymer, or any combination thereof. The conductive polymer includes at least one of polythiophene and polycationic polymer. More specifically; the polymer binder is selected from at least one of poly(3,4-ethylenedioxythiophene(PEDOT), poly(3,4-ethylenedioxythiophene)-polystyrene sulfonic acid (PEDOT:PSS), polyaniline and polypyrrole.

Generally, polythiophene has a structure specified as:

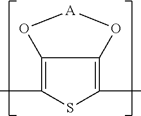

wherein A is an alkylene radical with 1–4 carbon, or a substituted C1-C4 alkylene radical.

The structure of polycationic polymer is specified as:

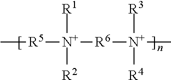

Wherein, the R¹, R², R³ and R⁴ are C1-C4 alkyl radicals, R⁵ and R⁶ are saturated or unsaturated alkylene, aryl alkylene or xylylene.

Additionally, the graphene ink of the present invention further includes a plurality of electrically or thermally conductive particles used to fill up the vacancy among the graphene sheets, which are formed after being stacked and sprayed. Therefore, the electrical and thermal conductivities of the graphene ink are further improved. The electrically or thermally conductive particles are selected from a group consisting of metal particles, ceramic particles and carbon nanotubes. Specifically, the metal particles are selected from a group consisting of at least one of gold, silver, copper, nickel, iron, titanium, zirconium and aluminum. Also, the grain size of electrically or thermally conductive particles is smaller than the lateral size of the graphene sheet.

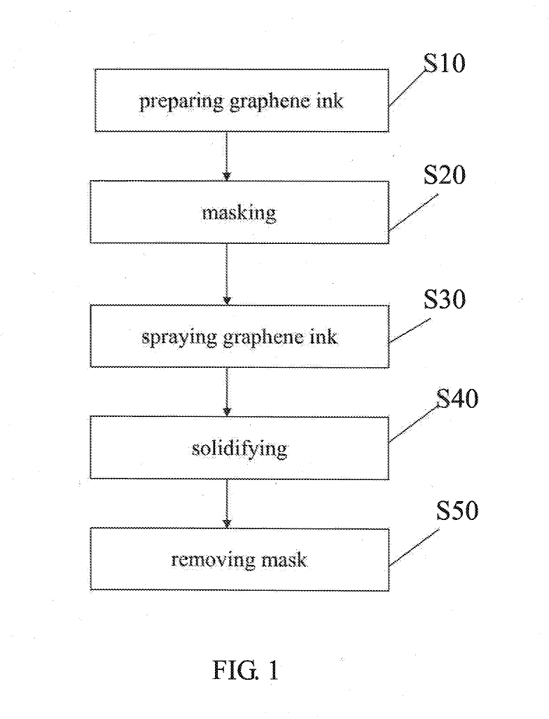

FIG. 1 illustrates the processing steps of the method for manufacturing graphene pattern according to the present invention. As shown in FIG. 1, the method tier manufacturing graphene pattern of the present invention includes the steps of preparing S10, masking S20, spraying S30, solidifying S40 and removing S50. In the step S10, the graphene sheets are first manufactured by means of redox reaction and heat-source-contact peeling off, and the graphene ink as mentioned above is then prepared.

The step S20 is performed to form a patterned photoresist or provide a patterned mask on an insulation substrate so as to mask the insulation substrate. Next, the graphene ink is sprayed onto the insulation substrate in the step S30, such that the surface region of the insulation substrate not masked by the patterned photoresist or the patterned mask is covered with the graphene ink. In the Step S40, the sprayed graphene ink on the insulation substrate is heated to evaporate volatile matters thoroughly so as to solidify the graphene ink. Finally, the step S50 is performed to remove the patterned photoresist by a chemical means or the patterned mask by a mechanical means so as to leave the solidified graphene ink as a graphene pattern on the insulation substrate. The insulation substrate is implemented by a PET (polyethylene terephthalate) substrate, a BT (Bismaleimide Triazine) substrate or a glass fiber substrate used in the traditional printed circuit board (PCH), or a glass or a plastic tape. Therefore, the graphene pattern is manufactured in various forms, like circuit board, conductive glass or conductive tape.

Hereinafter, illustrative examples 1˜3 of the graphene ink implemented by the method of the present invention from different formulations will be described in detail. Also, the electrical conductivity of the final film, that is, the graphene pattern, formed after the spraying step is measured.

In the following examples, the graphene sheets are manufactured by means of redox reaction and heat-source-contact peeling off. Specifically, 10 g of graphite powder is mixed with 230 ml of sulfuric acid, and then 30 g of potassium permanganate (KMnO₄) is slowly added to the mixed solution in an ice bath to maintain 20° C. with continuously stirring up. After being dissolved, the solution is stirred for 40 min at 35° C. Next, 460 ml of deionized water is slowly added, and the solution is stirred for 20 min at 35° C. After the reaction finishes, 14 L of deionized water and 100 ml of hydrogen peroxide (H₂O₂) are poured. After standing for 24 hours, the mixture is cleaned by 5% hydrochloric acid and then filtered and dried in vacuum to obtain the powder of graphite oxide. Subsequently, the powder of graphite oxide is in contact with the 1100° C. heat source in vacuum so as to peel off to form graphite powder material to be processed by reduction. The graphite powder material is then placed at 1400° C. with 5% hydrogen and 95% argon to undergo reduction and heated processes so as to obtain the graphene sheets with oxygen content less than 1.5 wt %.

In the examples 1˜2, the graphene sheets are placed into water, and poly (3, 4-ethylenedioxythiophene)-polystyrene sulfonic acid (PEDOT:PSS) served as the dispersion agents are added to form the graphene suspension solution with a concentration of 2,500 ppm and surface potential of −33 mV. The polymer binder is added to form the graphene ink. The graphene ink is sprayed with high pressure onto the PET substrate, and then measured to examine its electrical conductivity. The measured result is shown in Table 1 as below, where “T” is sprayed thickness and “C” is the electrical conductivity.

TABLE 1

| Examples | formulation | binder | Binder wt % | T (μm) | C (S/cm) |
|---|---|---|---|---|---|
| Example 1 | Graphene sheet | None | — | 4 | 38 |
| Example 2 | Graphene sheet | Polyvinyl | 10 | 4 | 14 |
| | | alcohol | | | |
| Example 3 | Graphene | PEDOT: | 0.1 | 5 | 43.8 |
| | sheet/carbon | PSS | | | |
| | nanotube (3:2) | | | | |

In the example 3, the above graphene sheets and carbon nanotubes, which are mixed by a ratio of 3:2, are added into water and poly(3,4-ethylenedioxythiophene)-polystyrene sulfonic acid (PEDOT:PSS) served as the dispersion agents are further added. to the mixture such that the concentration of the suspension solution is 2,500 ppm and its surface potential is −33 mV. 0.1 wt % of PEDOT: PSS served as the binder is additionally added to the suspension solution to form the graphene/carbon nanotuhe composite ink. Next, the composite ink is sprayed with high pressure onto the surface of the PET substrate to form a coating layer with a thickness of 5 μm. By measurement, the conductivity of the resultant coating layer is 43.8 S/cm.

From the above-mentioned, one of the aspects provided by the present invention is that the graphene ink is formed of the graphene with excellent electrical and thermal conductivities, and the graphene ink is easy to spray onto the target product and patterned to form the graphene pattern or conductive film. Therefore, the present invention can specifically implement various graphene products formed of the graphene.

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed

1. A graphene ink comprising:
a dispersion solution including at least one solvent, wherein the dispersion solution has a surface tension between 35 mJ/m² and 55 mJ/m², and occupies a proportion of more than 99% by weight based on a total graphene ink weight;
a polymer binder dissolved in the dispersion solution to form a colloidal solution and occupying a proportion between 0.01 and 0.5% by weight based on the total graphene ink weight; and
a plurality of graphene sheets dispersed thoroughly in the colloidal solution and occupying a proportion between 0.1 and 5% by weight based on the total graphene ink weight,
wherein the graphene ink has a viscosity less than 100 cp and a surface potential greater than 30 mV or less than −30 mV.

2. The graphene ink as claimed in claim 1, wherein the dispersion solution further includes a modifying reagent, the solvent is selected from a group consisting of at least one of water, organic solvent and ionic solution, and the modifying reagent is a surfactant and/or a dispersant for modifying the surface tension.

3. The graphene ink as claimed in claim 2, wherein the modifying reagent is selected from a group consisting of at least one of organic acids, alcohols, aldehydes, esters, amines, inorganic bases and inorganic salts.

4. The graphene ink as claimed in claim 1, wherein the graphene sheet has a shape of flake with a thickness of 1˜10 nm and a lateral size of 1˜10 μm, a ratio of the lateral size to the thickness of the graphene sheet is greater than 1,000, a specific area of the graphene sheet is more than 400 m²/g, and the graphene sheet has a contact angle with respect to the colloidal solution within a range of 45 to 80 degrees.

5. The graphene ink as claimed in claim 1, wherein the polymer binder consists of at least one of a thermoplastic resin, a thermoset resin, a cellulose and a conductive polymer.

6. The graphene ink as claimed in claim 5, wherein the conductive polymer consists of at least one of polythiophene and polycationic polymer, polythiophene has a structure specified as: 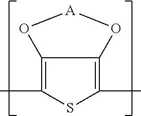
where A is an alkylene radical with 1˜4 carbon, or a substituted C1-C4 alkylene radical, and polycationic polymer has a structure specified as: 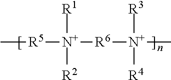
where R¹, R², R³ and R⁴ are C₁-C₄ alkyl radicals, R⁵, R⁶ are saturated or unsaturated alkylene, aryl alkylene or xylylene.

7. The graphene ink as claimed in claim 1, further comprising a plurality of electrical or thermal conductive particles with a grain size smaller than the lateral size of the graphene sheet, wherein the electrical or thermal conductive particles are metal particles, ceramic particles or carbon nanotubes.

8. The graphene ink as claimed in claim 7, wherein the metal particles are selected from a group consisting of at least one of gold, silver, copper, nickel, iron, titanium, zirconium and aluminum.

9. A method for manufacturing graphene pattern, comprising:
preparing a graphene ink including a dispersion solution, a polymer binder and a plurality of graphene sheets, wherein the dispersion solution has a surface tension between 35 mJ/m² and 55 mJ/m², the polymer binder is dissolved in the dispersion solution to form a colloidal solution, the graphene sheets are dispersed in the colloidal solution with a concentration greater than 0.1 g/L and the polymer binder in the colloidal solution is less than 10 wt % such that the graphene ink has a viscosity less than 100 cp and a surface potential greater than 30 mV or less than −30 mV;
masking an insulation substrate by coating a patterned photoresist or providing a patterned mask on the insulation substrate;
spraying the graphene ink onto the insulation substrate such that a surface region of the insulation substrate not masked by the patterned photoresist or the patterned mask is covered with the graphene ink;
solidifying the graphene ink by heating and evaporating volatile matters contained in the graphene ink with heat; and
removing the patterned photoresist or the patterned mask by a mechanical means to leave the solidified graphene ink as a graphene pattern on the insulation substrate.

10. The method as claimed in claim 9, wherein the insulation substrate includes one of PET (polyethylene terephthalate) substrate, a BT (Bismaleimide Triazine) substrate, a glass fiber substrate, a glass and a plastic tape.
